(19) United States
(12) Patent Application Publication
(10) Pub. No.: US 2024/0353557 A1
(43) Pub. Date: Oct. 24, 2024

(54) METHOD FOR DETECTING A TRAILER

(71) Applicant: Robert Bosch GmbH, Stuttgart (DE)

(72) Inventors: Matthias Eix, Waeschenbeuren (DE); Kai Buechler, Heilbronn (DE); Sebastian Muth, Aachen (DE)

(21) Appl. No.: 18/586,924

(22) Filed: Feb. 26, 2024

(30) Foreign Application Priority Data
Apr. 24, 2023 (DE) 10 2023 203 758.0

(51) Int. Cl. G01S 13/931

(52) U.S. Cl. CPC G01S 13/931; G01S 2013/93272

(57) ABSTRACT

A method for detecting a trailer being towed by a towing vehicle using a radar system of the towing vehicle. According to an example embodiment of the present invention, the method includes the following steps: estimating parameters of a trailer model using location data of the radar system; predicting changes in the location data using the trailer model and using movement data of the towing vehicle; comparing measured changes in the location data with the predicted changes and deciding, with the aid of a classification algorithm and using the comparison results, whether the location data represents a trailer or not.

### CROSS REFERENCE

The present application claims the benefit under 35 U.S.C. § 119 of German Patent Application No. DE 10 2023 203 758.0 filed on Apr. 24, 2023, which is expressly incorporated herein by reference in its entirety.

### FIELD

The present invention relates to a method for detecting a trailer being towed by a towing vehicle using a radar system of the towing vehicle.

### BACKGROUND INFORMATION

Motor vehicles are often equipped with a radar system that provides location data about the traffic environment for a driver assistance system, for example for speed and distance control, blind spot monitoring and/or a lane change assistant. If the vehicle is towing a trailer, this requires certain adjustments to the functionality of the driver assistance system. For example, a speed limit has to be observed when driving with a trailer. Blind spot monitoring may give false warnings because the radar system interprets the trailer as another vehicle in the blind spot (e.g., when cornering). For a lane change assistant, the warning zone has to be adapted to the greater length of the towing vehicle and trailer combination.

A trailer generally has a lighting system that has to be connected by coupling a plug into the vehicle's electrical system. Establishing this electrical connection can at the same time produce a detection signal that indicates of the presence of a trailer. However, since the electric coupling can be defective or the coupling can be forgotten, it would be desirable if the presence of a trailer could also be detected in some other way so that a higher level of redundancy is achieved.

A method of the aforementioned type, in which the presence of a trailer is detected using the radar system of the towing vehicle, is described in U.S. Patent Application Publication No. US 2015/325126 A1. The method uses the fact that the trailer is always the same distance from the towing vehicle when driving straight ahead and that, even when cornering, the distance measured by the radar system changes only within very narrow limits to distinguish between a trailer and another vehicle following at a short distance.

A similar method, in which, if a trailer is present, the length of the vehicle and trailer combination is measured as well, is described in U.S. Pat. No. 9,211,889 B1. For this purpose, the distance of reflection centers located in the rear end region of the trailer is measured when cornering.

A method, in which the radar system is used to measure important characteristics of a trailer, such as the length, the number of axles and the height of the trailer, is described in German Patent Publication No. DE 11 2020 000 325 T5. However, this assumes that it is already known from another source that a trailer is even hitched to the vehicle.

### SUMMARY

An object of the present invention is to provide a method that enables a more reliable decision as to whether a trailer is hitched to the vehicle or not.

This object may be achieved according to an example embodiment of the present invention by a method comprising the following steps:
estimating parameters of a trailer model using location data of the radar system,
predicting changes in the location data using the trailer model and using movement data of the towing vehicle,
comparing measured changes in the location data with the predicted changes and deciding, with the aid of a classification algorithm and using the comparison results, whether the location data represents a trailer or not.

In the method according to the present invention, a more reliable differentiation between trailers and other objects in the surroundings of the vehicle is enabled by modeling the dynamics of a trailer towed by the towing vehicle and comparing it with the dynamics measured by the radar sensor. Since the dynamics of a towed trailer differ significantly from the dynamics of an independent vehicle following at a short distance, it is possible to decide with a high degree of certainty whether the location data really indicate the presence of a trailer.

Important parameters of the trailer model that affect the dynamics of the trailer are, for example, the distance between the trailer hitch and the axle of the trailer and, for multi-axle trailers, the number of axles and the wheelbase. In conjunction with the yaw rate of the towing vehicle, these parameters determine the change in the articulation angle between the longitudinal axis of the trailer and the longitudinal axis of the towing vehicle. This change in the articulation angle can in turn be used to predict how the location data, i.e., the distances, relative speeds and direction angle in azimuth and possibly also in elevation of the reflection points present on the trailer will change. The classification algorithm can then be used to check whether the deviations between the predicted and the measured changes are so small that the assumption that the location data originate from a trailer described by the trailer model is the only plausible hypothesis.

Advantageous embodiments and further developments of the present invention will emerge from the disclosure herein.

In the case of rotating objects, such as the wheels of a vehicle or trailer, the Doppler shift of the radar reflections exhibits a characteristic dependence on the elevation angle. This effect, known as the micro-Doppler effect, makes it possible to reliably identify the wheels of a trailer or vehicle. When cornering, the correlation between the change in the distance of the wheel measured by the radar sensor and the change in the measured azimuth angle can be used to determine the distance between the wheel and the hitch position and integrate it into the trailer model. If the towing vehicle has two radar sensors at the rear that can detect the wheels on both sides of the trailer at the same time, the distance between the hitch position and the axle can also be determined directly. If the wheels of the trailer are within the detection range of the radar sensors only when cornering, the distance between the hitch position and the axle can still be determined if each of the two wheels on the axle has been detected at least once during alternating cornering to the right and left.

The more location data is available, the more accurate the estimation of the parameters of the trailer model can be. At least in the initial phase, shortly after the start of the trip, the trailer model can therefore be continuously updated until the model parameters converge to values that are compatible with the overall location data history. If this convergence has not yet occurred after a certain number of location events, the classification algorithm decides that no trailer is present.

According to an example embodiment of the present invention, the classification algorithm can be trained using machine learning methods such that it can reliably distinguish between the classes “trailer” and “non-trailer” despite unavoidable error tolerances of the location data. The training data can be generated when driving with different types of trailers, so that a robust classification is achieved even for trailers with different characteristics.

In addition to trailers in the strict sense, the trailer model can also include towed vehicles, with the length of the tow rope or the tow bar as the most relevant model parameter. In that case, it would also be possible to recognize towing situations automatically and adapt the functionality of the driver assistance system accordingly.

An embodiment example of the present invention is explained in more detail in the following with reference to the figures.

### BRIEF DESCRIPTION OF THE DRAWINGS

FIG. 1 shows a block diagram of a motor vehicle radar system with which an example embodiment of the method according to the present invention can be carried out.

FIGS. 2 and 3 show sketches of two temporally successive traffic situations to explain the method according to the present invention.

### DETAILED DESCRIPTION OF EXAMPLE EMBODIMENTS

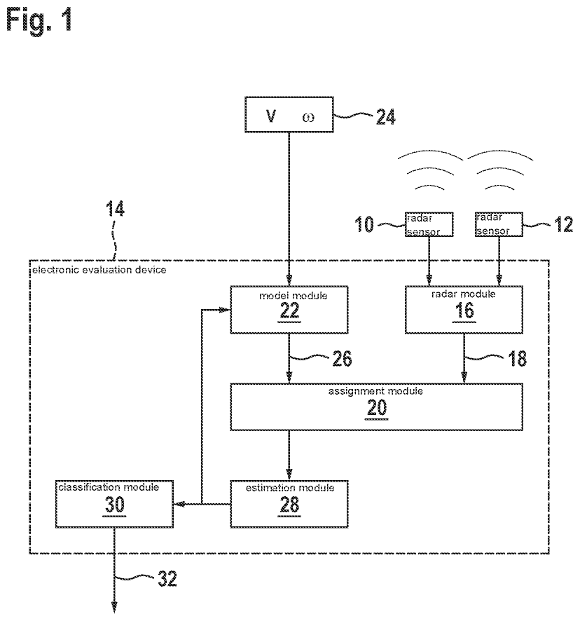

The radar system shown in FIG. 1 comprises two radar sensors 10, 12 and an electronic evaluation device 14. The radar sensors 10, 12 are installed on the left and right rear corners of a motor vehicle and respectively monitor a space behind and to the left or right of the vehicle. The detection ranges of the two radar sensors can optionally overlap with one another, so that the space directly behind the vehicle can be acquired as well.

The evaluation device 14 comprises a radar module 16, which further evaluates the signals received and digitized by the radar sensors 10, 12 and calculates distances, relative speeds, azimuth angles and preferably also elevation angles of various reflection points on one or more located objects. Thus location data 18 is obtained and further analyzed in an assignment module 20. The assignment module 20 in particular searches for groups of radar reflections for which it can be assumed that they belong to the same object due to largely matching relative speeds. If the vehicle equipped with the radar system is a towing vehicle that is towing a trailer, the radar sensors 10, 12 will also receive radar reflections from the trailer, at least when cornering, and the assignment module 20 will assign these reflections to a common object, although it is not yet clear whether it is really a trailer or another vehicle. The average relative speed measured for these reflection points provides a first clue. Since the trailer is moving at the same speed as the towing vehicle, the measured relative speeds for a trailer will be close to zero. For objects, the relative speed of which deviates from zero by more than a specific threshold value, it can be ruled out from the outset that it is a trailer. However, even for objects the relative speed of which is nearly zero, there is the possibility that it is not a trailer, but a different vehicle that happens to be traveling at the same absolute speed as the ego vehicle.

To be able to resolve this uncertainty, the evaluation device 14 comprises a model module 22 in which different types of trailers can be modeled. Each trailer model is characterized by a set of parameters which include the distance between the hitch position and the (frontmost) axle of the trailer, for example, and, for multi-axle trailers, also the number of axles and the wheelbase. Other parameters can specify the width, height and length, and also the track width of the trailer.

The model module 22 receives data from the vehicle's own sensor system 24. This data includes in particular the absolute speed v and the yaw speed w of the vehicle, which will be referred to in the following as the towing vehicle, even if it is not certain whether a trailer is actually hitched to the vehicle.

The model module 22 models the dynamic behavior of the trailer based on the dynamic data of the towing vehicle and based on the model parameters. This in particular predicts how the location data of individual reflection points, which are located in different positions on the supposed trailer, will change as a function of the current speed v and the current change in the yaw rate w. When the yaw rate is zero, i.e. when driving straight ahead, neither the distances nor the relative speeds nor the azimuth angles of the reflection points change. The same applies if the yaw rate is different from zero (cornering) but has remained constant for an extended period of time. In that case, the towing vehicle and the trailer are moving on a circular path and the spatial relationships between the radar sensors and the various reflection points remain unchanged. Predicted values 26 for the location data of the reflection points are passed from the model module 22 to the assignment module 20 and compared there with the measured location data 18.

At the start of a trip, when no location data is available yet, the model parameters in the model module 22 are set to default values that characterize the most common trailer type, for example. If a trailer is hitched to the vehicle, the model defined by the preset parameters will not describe the trailer correctly, so that the location data predicted using these models will deviate significantly from the measured location data. These deviations are used in an estimation module 28 to estimate new parameter values that minimize the deviation between the predicted values and the measured values.

A classification module 30 tracks the history of the deviations and the model parameters. If the model parameters converge toward stable values at which the deviations between the predicted location data and the measured location data are below suitable threshold values, the classification module decides that the located object is indeed a trailer and a corresponding message 32 is output to a driver assistance system of the towing vehicle. As long as the deviations remain greater than the threshold values, no trailer message is output. The classification module 30 similarly decides that no trailer is hitched to the vehicle if the deviations are temporarily below the threshold value but the model parameters fluctuate over time, because the deviations can only be minimized by continuously adjusting the model parameters that describe the trailer. The threshold values for the deviations and for the fluctuation range of the model parameters can be determined by training the classification module 30 using machine learning, for example during test drives with various types of trailers and with following vehicles that could be confused with trailers.

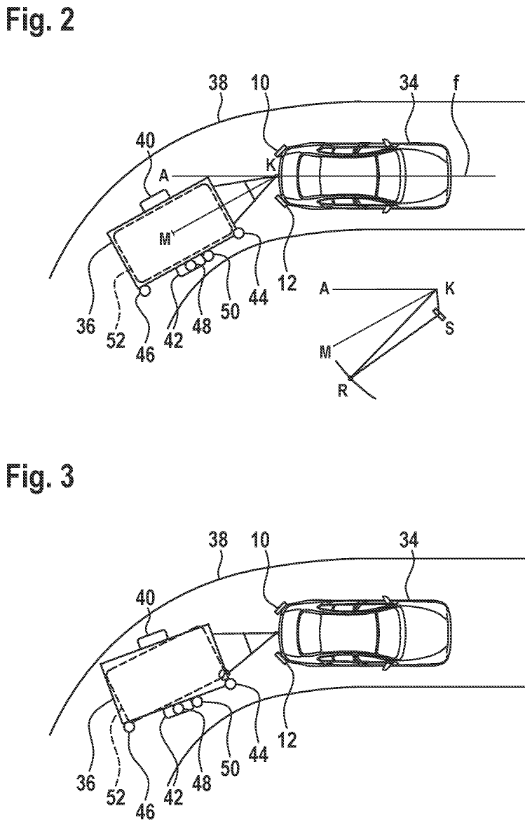

To illustrate the method, FIG. 2 shows a traffic situation in which a combination of a towing vehicle 34 and a trailer 36 is negotiating a bend on a roadway 38. The two radar sensors 10, 12 are indicated schematically at the rear of the towing vehicle 34.

The trailer 36 in this example is a single-axle trailer with left and right wheels 40, 42. During cornering, the longitudinal axis f of the vehicle 34 forms an articulation angle AKM with the longitudinal axis a of the trailer, wherein A is a point on the longitudinal axis f of the vehicle, K is the position of a trailer hitch and M is the center of the axle of the trailer 36. In the shown example, the articulation angle is so large that the left side of the trailer 36 is outside the detection range of the left radar sensor 10. However, the right radar sensor 12 can receive radar reflections from various reflection points 44, 46 on the body of the trailer and from other reflection points 48, 50 on the right wheel 42 of the trailer.

The points A, K, and M, as well as two points R and S, which indicate the position of the reflection point 50 on the trailer wheel and the position of the radar sensor 12, are shown again separately in FIG. 2 in a diagram that illustrates the geometric relationships. The distance KS can be measured when the trailer hitch is fitted, and the distance RS as well as the angle RSK (at point S) can be measured using the radar sensor 12. The triangle RSK is thus determined entirely, and therefore the position of the reflection point 50 (point R) relative to the towing vehicle 34 is known. The same applies to all of the other reflection points.

The radar echo from the upper apex of the wheel 42 exhibits a Doppler shift to higher frequencies due to the rotation of that wheel. The echo from the reflection point 50 at the level of the trailer axle does not exhibit this Doppler shift, and a reflection point near the lower apex of the wheel 42 exhibits a Doppler shift to smaller frequencies. This pattern clearly indicates that the reflection points 48 and 50 originate from the wheel of the trailer. This enables the number of axles of the trailer to be determined.

In almost all trailer models, the trailer has a substantially uniform width along its length. It can therefore be assumed that the reflection points 44 and 46 and possibly further reflection points on the side surface of the trailer body lie on a straight line that extends parallel to the longitudinal axis a of the trailer. Since the positions of these reflection points are known, the orientation of these straight lines and thus also the articulation angle of the AKM can be determined. The distance between the hitch position and the center of the axle can also be determined using the measurement data.

The distance between the center of the axle M and the reflection point 48 at the apex of the wheel 42 is equal to the half track width of the trailer. Since the position of the center axis a is known, the location data can also be used to determine the half track width of the trailer 36.

Important parameters of the trailer model can thus be determined using just a single radar measurement.

If the articulation angle AKM changes when negotiating a curve, all of the reflection points of the trailer move in circles around point K. If the positions of one and the same reflection point are known for three different points in time between which the articulation angle has changed, the radius and the position of the midpoint K of the circle can be determined. The hitch position at point K can thus be ascertained using several radar measurements, even if it was not known at the outset.

In the situation shown in FIG. 2, the towing vehicle 34 is just exiting the curve, so that its yaw rate has decreased to zero and then remains zero. The yaw rate of the trailer 36, that differs from zero, can be predicted using the trailer model.

FIG. 3 shows the state at a somewhat later point in time, when the trailer has also reached the end of the curve and the articulation angle has decreased. If the positions of the reflection points 44 and 46 are measured again in FIG. 3, it can be checked whether the yaw rate predicted using the data in FIG. 2 corresponds to the current measurements. If the model parameters are correct and the located object is really a trailer, the predicted yaw rate will be confirmed in the state according to FIG. 3.

In FIG. 2, the outline of a car 52 that could produce the same reflection points 44 and 46 is superimposed in dashed lines on the outline of the trailer 36. If, for any reason, for example due to signal noise or shadowing effects, it is not possible to see that the that the reflection points 48 and 50 originate from a wheel, the located object could also be the car 52. Since a car has steerable front wheels, however, its dynamics when negotiating a curve differ from the dynamics of a trailer. Even if the driver of the car 52 is following the towing vehicle 34 at a constant distance so that the relative speed of the midpoint is zero, the yaw rate of the car will generally be different from the yaw rate predicted for a trailer, as shown in FIG. 3. Given these conditions, the classification module 30 would decide that no trailer is present.

Modeling the dynamics of a trailer using a trailer model thus makes it possible to achieve a reliable distinction between trailers and other vehicles.

What is claimed is:

1. A method for detecting a trailer being towed by a towing vehicle using a radar system of the towing vehicle, comprising the following steps:
estimating parameters of a trailer model using location data of the radar system;
predicting changes in the location data using the trailer model and using movement data of the towing vehicle; and
comparing measured changes in the location data with the predicted changes and deciding, using a classification algorithm and using results of the comparison, whether the location data represents a trailer or not.

2. The method according to claim 1, wherein in which the parameters of the trailer model include at least one of the following variables: a distance between a hitch position and an axle of the trailer, a number of axles of the trailer, a wheelbase of a multi-axle trailer, a track width of the trailer, a width of the trailer, a length of a trailer, and a height of the trailer.

3. The method according to claim 1, wherein in the parameters of the trailer model are continuously updated using current location data.

4. The method according to claim 1, wherein wheels of an object potentially to be classified as a trailer are recognized using a micro-Doppler effect.

5. The method according to claim 1, wherein machine learning is used to optimize the classification algorithm.

6. The method according to claim 1, wherein the trailer model also includes a model of a towed vehicle.

7. A towing vehicle, comprising:
at least one radar sensor; and
an electronic evaluation device configured to detect trailer being towed by the towing vehicle using the radar sensor of the towing vehicle, the electronic evaluation device being configured to:
estimate parameters of a trailer model using location data of the radar system,
predict changes in the location data using the trailer model and using movement data of the towing vehicle, and
compare measured changes in the location data with the predicted changes and deciding, using a classification algorithm and using results of the comparison, whether the location data represents a trailer or not.
